(19) United States
(12) Patent Application Publication
(10) Pub. No.: US 2020/0342522 A1
(43) Pub. Date: Oct. 29, 2020

(54) System and Method for Developing Voice Interactive Ecommerce Store

(71) Applicant: Blutag, Inc., New York, NY (US)

(72) Inventors: Rahul Agarwal, Hillsborough, NJ (US); Shilp Agarwal, Hoboken, NJ (US)

(73) Assignee: Blutag, Inc., New York, NY (US)

(21) Appl. No.: 16/395,440

(22) Filed: Apr. 26, 2019

(51) Int. Cl. G06Q 30/06; G06F 8/38; G06Q 30/02; G06F 16/9032; G10L 15/22; G06F 3/16

(52) U.S. Cl. CPC G06Q 30/0643; G06F 8/38; G06Q 30/0631; G10L 2015/223; G06F 16/90332; G10L 15/22; G06F 3/167; G06Q 30/0239

(57) ABSTRACT

Systems and methods for easily creating and operating a voice-interactive shopping experience are disclosed. A merchant creates a voice store using a voice store creator platform. According to one process, an existing online store connects to the platform. The platform creates a voice-searchable catalog from data available on the existing online store. The platform enables the merchant to create a voice shopping experience using plain language instructions and without programming experience. Customers access the voice store with voice-enabled devices such as mobile phones or personal computing devices. The customer searches and shops using voice interaction.

### FIELD OF THE INVENTION

This application relates generally to the field of voice interactive systems, and more particularly to a system and method for generating a voice interactive shopping assistant.

### BACKGROUND

Developing an attractive and functional website was long a barrier to launching an ecommerce business. In the infancy of commerce carried out on the World Wide Web, businesses acquired specialized expertise for creating, launching and modifying ecommerce stores. Even as more specialists entered the field of website development, the ability to generate and launch an ecommerce store was beyond the ability of those lacking special training in the field.

As the demand for ecommerce stores grew, user-friendly solutions for creating web stores became available. Developers created platforms to help users with little or no expertise in web design, networking or computer programming create websites and ecommerce stores. These platforms provide plain language menus and selection driven process flows that enable a person to create, launch and maintain an ecommerce store without advanced expertise in coding. The web platform known as SHOPIFY is one example of a platform for creating and maintaining an ecommerce business.

Voice interaction with computing devices has advanced is a commercially available feature on popular computing ecosystems. AMAZON.COM, Inc. and Google LLC provide voice-interaction technologies called ALEXA and GOOGLE HOME respectively. These and other voice-enabled interfaces allow users to interact with their computing devices and with the World Wide Web using voice commands.

Despite these computing capabilities, businesses that wish to equip their ecommerce sites with voice interactivity have little or no cost-effective means to do so. One method would be to create and program this functionality on a site-by-site basis, but the cost of acquiring the necessary expertise is prohibitive. As a result, there remains a need for systems and methods for creating and deploying voice-interaction assistants for ecommerce sites, without requiring special or expert programming knowledge on the part of the developer.

### SUMMARY

A system and method according to the principles of the invention provide a platform for creating voice-interactive ecommerce stores without the need for specialized programming expertise. A voice-store-creator system according to the principles of the invention includes a merchant-facing interface where a merchant interacts with the system to create a voice-interactive store.

The system's computing device presents outputs and receives inputs from the merchant-facing interface and connects to an ecommerce store backend in response to commands entered on the interface. A data store or other memory device stores product data received from the ecommerce backend and also stores voice-assistant interactions, such as prompts and responses that the voice assistant will provide to a voice store user. Voice interactions can be generated on the fly or stored in advance. A voice-assistant interaction selection module executable on the computing device presents the voice-assistant interactions for selection on the merchant-facing interface. Voice interactions can be presented for selection in text, in audio or in other formats and syntaxes depending on the requirements for voice store.

Voice store creation according to the invention includes producing a voice-interactive product catalog. In one embodiment, an augmentation module executable on the computing device augments the product data from an existing ecommerce backend. The augmented product data enables voice-interactive searching. The augmentation module includes a set of rules applied to the product data, and produces a set of tagged product data where the tags and other product fields enable or otherwise facilitate voice-interactive searching. The augmented data resides on the voice store creator platform in one embodiment, but can also reside in other locations.

The augmentation module also processes product image data and generates metadata from the images like color, pattern and textual tags. The tags and other product fields can be considered searchable fields. In one embodiment, the augmentation module orders the searchable fields such that the search algorithm applies the augmentation module search order.

A voice store creator according to the principles of the invention also includes a voice interaction assistant generation module. This module generates a voice interaction assistant using the user selected voice-assistant interaction templates. In one embodiment, the voice-interaction assistant module produces the selectable voice interactions provided by the selection module. A publication module executable on the computing device publishes the voice-interaction assistant to a voice store platform.

Another aspect of a voice store creator comprises a test module, which when executed publishes a voice-assistant interaction test case to the merchant-facing interface. In response to inputs on the merchant-facing interface, the test module causes the generation module to generate a test voice-interaction assistant publishable to the voice store platform. Once published, the merchant can interact with the voice assistant to test the voice interactions of the voice store.

Aspects of the invention also include methods for voice store creation. One embodiment of the methods for creating a voice store includes receiving product data, augmenting the data to produce voice-searchable product data, receiving voice-assistant interaction selections, generating a voice assistant from the interactions, and publishing the voice assistant to the voice store platform. Additional aspects of the method include additional templates or examples allowing the merchant to create coupons or deals for presentation to users of a voice assistant. Yet another aspect of the invention includes applying algorithms for customizing voice interactions and offerings to particular users.

### BRIEF DESCRIPTION OF THE DRAWINGS

In the drawings:

FIG. 1 depicts a diagram of the salient components of voice store system 100 in accordance with the prior art.

FIG. 2 depicts a diagram of the salient components of voice store creator system 200 in accordance with an illustrative embodiment of the present invention.

FIG. 3 depicts a block diagram 300 of voice store creation in accordance with an illustrative embodiment of the present invention.

FIG. 4 depicts an interface 400 in accordance with an illustrative embodiment of the present invention.

FIGS. 5A and 5B depict another interface 500 in accordance with an illustrative embodiment of the present invention.

FIG. 6 depicts another interface 600 in accordance with an illustrative embodiment of the present invention.

FIGS. 7A and 7B depict another interface 700 in accordance with an illustrative embodiment of the present invention.

FIG. 8 depicts another interface 800 in accordance with an illustrative embodiment of the present invention.

### DETAILED DESCRIPTION

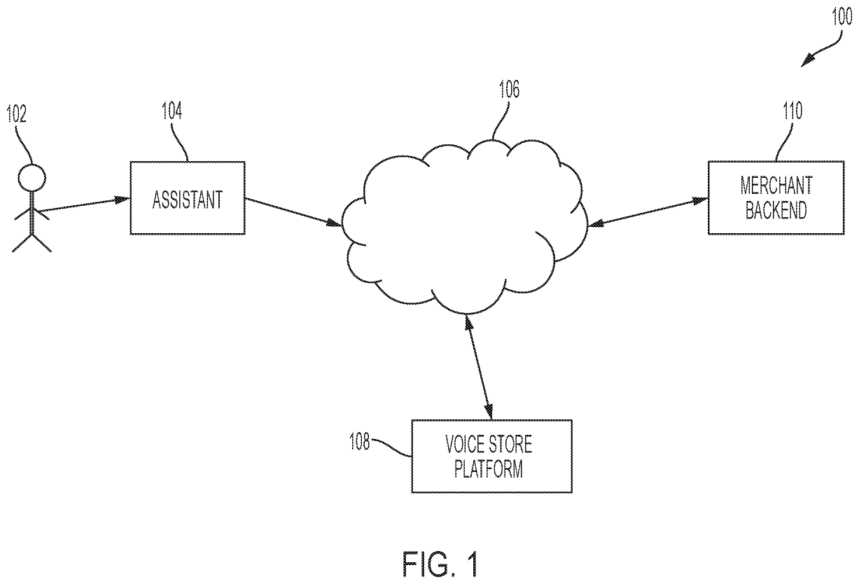

FIG. 1 shows the salient components of a voice-interactive ecommerce system 100 in accordance with the prior art. For ease of illustration, the system is shown with a single user or shopper 102, although in actuality there are many shoppers. The system 100 comprises a merchant backend system 110, which operates as the voice-enabled ecommerce backend. This system 110 provides the functionality for conducting an ecommerce transaction. Among the prior art functions that are relevant here, the system 110 provides the product data necessary for the system. This includes, but is not limited to, the product identification, product images, prices, bundles, descriptions and other data desirable for an ecommerce experience. Also included in the system 110 are the interfaces and APIs known in the art that permit access to the product data and other data in the merchant backend 110 that the merchant deems desirable to make available to other systems. It is a limitation of this prior art system 100 that the voice-searchable product catalog must be manually enabled for voice searching.

FIG. 1 also illustrates a prior art voice store platform 108. In this example, the voice store platform 108 enables the voice-interactive shopping experience for the shopper, and provides the ability to interact with the specially voice-enabled merchant backend 110 to carry out a voice-assisted transaction. Included in the voice store platform 108 are the computer-implemented systems for providing voice interactions to the user. These interactions can be static, where the system stores different interactions and then selects them for presentation to the user based on the user inputs to the voice assistant 104, as will be explained below.

The voice assistant 104 provides the user-interface functionality and interacts with the voice-enabled ecommerce store to deliver the user 102 the voice-interactive shopping experience. Voice-interactive assistant 110 can be embodied as an application residing on a user's mobile terminal or even as a part of the mobile's operating system. They can be embodied as applications executing on a computer or they can be embodied as an appliance. For example, APPLE INC. provides a voice-interactive assistant functionality known as SIRI that operates on mobile devices and on desktop and laptop computers. AMAZON.COM, Inc. provides a voice assistant known as ALEXA, which also operates on mobiles, laptops and desktops. In addition, AMAZON.COM, Inc. provides a family of appliances that permit users to interact with applications and aspects of the World Wide Web using the appliance. A person of ordinary skill in the art knows how to manually program and deploy ecommerce stores on these prior art systems.

In the illustrated prior art system 100, the voice assistant 104, the voice store platform 108 and the merchant backend 110 interconnect over a cloud network 106, which can be the World Wide Web. Interconnecting over network 106, while known in the prior art, is not limiting. A person of ordinary skill in the art knows how to interconnect the salient components of a prior art interactive system 100 in desirable network configurations to create a voice-interactive ecommerce store. It is a disadvantage of these prior art systems, however, that deploying such an ecommerce store is inconvenient, expensive and requires specialized expertise, including expertise to program the voice interactions and expertise to create a voice-searchable product catalog.

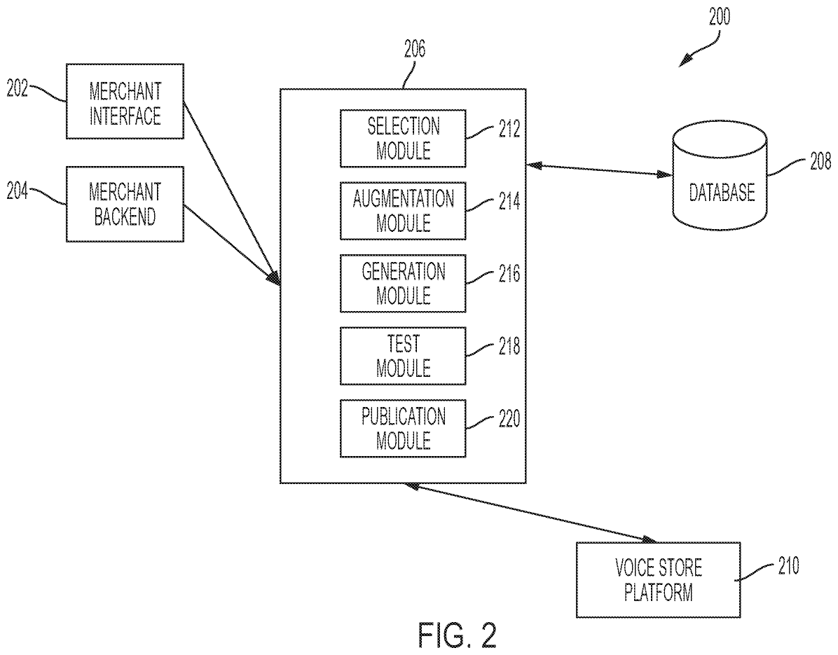

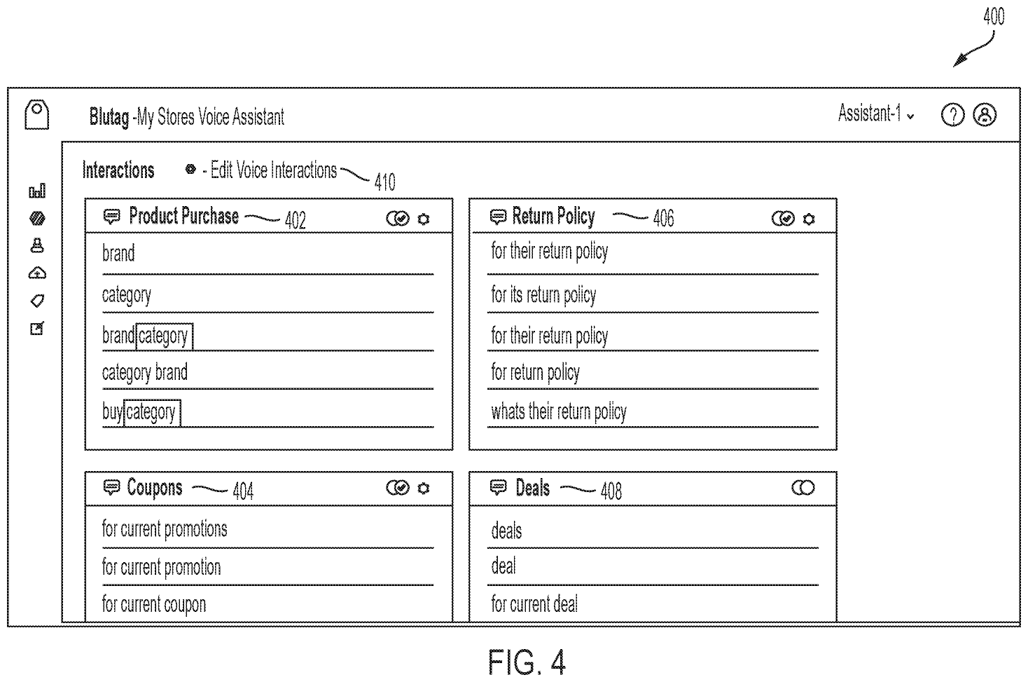

FIG. 2 shows a diagram of a voice store creator system 200 according to the principles of the invention. The illustrated embodiment 200 includes a merchant interface 202, a merchant backend 204, a computing device 206 capable of executing various functional modules 212, 214, 216, 218 and 220, a data store 208 and a voice store platform 210. The merchant interface 202 provides a computer-user interface from which the user 202 can interact with the modules executing on the computing device 206. In an exemplary embodiment, the merchant interface includes a keyboard, a video monitor and a mouse or some similar cursor control device. The interface 202 also includes a computing device for executing the software routines necessary to provide a computer-human interface. In one embodiment, the interface is a graphical user interface provided in well-known fashion. The functional aspects of the interface permit the computing device 206 to provide the user access to all the commands and selections necessary for the human user to build a voice store with the system 200. Aspects of an exemplary interface are discussed in additional detail with references to FIGS. 4-8. It will be apparent to a person of ordinary skill in the art having read this disclosure how to make and use the interface 202.

The merchant backend 204 comprises the backend of an ecommerce store. In accordance with the illustrative embodiment, the merchant backend 204 comprises the ecommerce store product data, where product data means the data embodying all the attributes of the products available for sale from the ecommerce store. Examples of product attributes include, but are not limited to, names, serial numbers, availability status, quantities available, price, physical descriptors, product images, search fields, tags, metadata, inventory, color, packaging, shipping costs and any other attributes an ecommerce store may use in making a product available for sale. In addition to the product data, the backend 204 may include data related to customers of the ecommerce store, security platform, and other data or functions upon which the ecommerce store performs. In the illustrative embodiment, the merchant backend 204 product data is accessible to third party applications via APIs or other interfaces. In the illustrated embodiment, a user sends commands via the interface 202 and instructs the backend 204 to provide product data to the computing device 206. These commands may include login credentials. It will be clear to persons having ordinary skill in the art after having read this disclosure how to make product data residing on a merchant backend 204 available to the computing device 206 via commands input on the merchant interface 202.

The computing device 206 is a data processing device comprising hardware and software that is configured to create voice assistance functionality and other voice store functionality for a voice store. The hardware includes a programmable processor and memory, which when operating in conjunction with the other components of the system 200 executes modules and processes data in accordance with the principles of the invention. Memory is non-transitory and non-volatile computer memory technology that is well known in the art. Memory stores an operating system, application software or modules, and elements (which comprise data, records, results, lists, etc.) It will be clear to those having ordinary skill in the art how to make and use alternative embodiments that comprise more than one memory; or subdivided segments of memory; or a plurality of memory technologies that collectively store the operating system, application software, and other elements. The specialized applications executed by the processor are illustratively denominated modules, and enable the system 200 to perform the operations and methods according to the principles of the invention.

The computing device 206 provides data to and interacts with the merchant interface 202 to provide the user selections and voice interaction functions (also called voice interactions) necessary for the user to implement a voice store according to the principles of the invention. Optionally the data store 208 may store the voice interactions the computing device 206 provides for selection to the user. Responsive to the user's commands, the computing device 206 connects to the merchant backend, such as by API's, so that the computing device 206 has access to the merchant product data.

The selection module 212 includes instructions executable on the computing device. When executing the selection module 212, the computing device 206 provides voice interactions for selection to the user interacting with the merchant interface. As will be discussed more fully, the selection module 212 permits the user to iteratively build a voice store without specialized knowledge. In one aspect of the principles of the invention, the selections module permits the user to build voice interactions on a product-by-product basis. It will be apparent to a person having ordinary skill in the art after having read this disclosure how to make and use a selection module according to the principles of the invention.

The augmentation module 214 includes instructions, which when executing on the computing device shapes and processes the product data to make the product data voice searchable. A rules engine applied to each product generates tags for voice assisted searching based on the content of the product data. For example, if product data indicates a product is mapped to the category “pants” and contains a keyword “dress” in an item name field, a rules engine can produce the tag “dress pants.” Additional category and field content in the product data can produce additional tags according to rules. Using the same example, if the category field indicates “men's”, then the rules engine can produce the tags “men's” and “men's dress pants.” Tags can be generated from other product data content and from existing tags in the product data. It will be apparent to a person having ordinary skill in the art after having read this disclosure how to make and use an augmentation module 214 and rules engine according to the principles of the invention.

The generation module 216 includes instructions which when executing on the computing device cause the computing device to process the selections, the augmented data and any voice store integration selections to generate a voice-interaction assistant application for shoppers. The generation module 218 further generates the necessary data and command responses that will permit a voice store to operate in conjunction with shopping inputs from the voice assistant.

In the illustrative embodiment, the generation module 218 generates the JAVASCRIPT Object Notation (JSON) structure for the voice store. The structure includes the phrases constituting the shopper's intent and slots for the object of the intent. For example, the JSON structure can include an intent to search for coupons and the product name the shopper is searching. The JSON syntax has been defined in IETF RFC 4627, as updated by RFC 7158/7159 and RFC 8259 in 2017, and in ECMA International Standard ECMA-404, which are included herein by reference. In one aspect of the illustrative embodiment, the generation module generates a “skill” or “action” publishable from the interface. It will be apparent to a person having ordinary skill in the art after having read this disclosure how to make and use a generation module according to the principles of the invention.

The illustrative embodiment 200 provides for creating interactive test cases accessible from the interface 202. Test module 218 generates a voice-assistant interaction test case and publishes it to the merchant-interface 202. In response to inputs from the merchant interface 202, the test module causes the generation module to generate a test voice-interaction assistant publishable to the voice store platform. In the exemplary embodiment, the test module 218 generates a JSON structure. The test module 218 when executed on the computing device can present a test store generated by the voice store platform to the merchant interface for testing. In this way, the merchant can test both the voice assistant and the shopping experience before going live to the public with a voice-assisted store.

A publication module 220 when executed on the computing device 206 causes publication of the voice interaction assistant to the voice store platform 210. Once published to the voice store platform, users may access the voice-interaction assistant for use in ecommerce shopping. Publishing to the voice store platform refers to sending the JSON structure of the voice store assistant to the voice platform, such as a skills store. Examples of skills stores include those of ALEXA and GOOGLE Actions. In an exemplary embodiment according to the principles of the invention, the user downloads the voice interaction assistant to a mobile device. In another embodiment, the voice interaction assistant resides on an appliance. A person having ordinary skill in the art having read this disclosure will understand how to make and use a publication module to publish the voice interaction assistant generated in the exemplary voice store creator.

The data store 208 is a digital data storage system that is responsible for receiving data, storing data, archiving data, and retrieving data in a fashion that is well known in the art. Illustratively, data store 208 is implemented as a hard disk drive that is part of system 200. Illustratively, data store 208 stores exemplary voice interactions for presentation on the interface 202 and stores selected interactions to be moved into memory when required by an application. It will be clear to those having ordinary skill in the art after reading the present disclosure how to make and use alternative embodiments wherein data store 208 is accessible to the computing device 206.

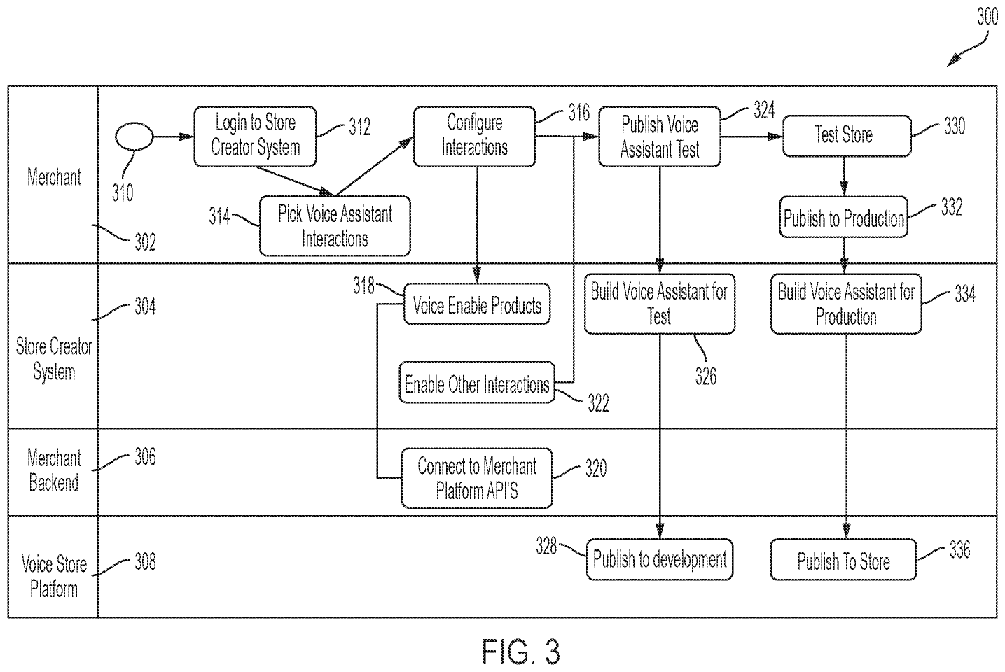

FIG. 3 depicts a block diagram 300 of an exemplary voice store creation method in accordance with the principles of the invention. The illustrated method can be carried out on the system 200 of FIG. 2. According to the exemplary method, a merchant 302 interacting with the merchant interface 202 can voice enable an existing ecommerce store without specialized programming knowledge or skill. Process commences at step 310. Optionally, the merchant logs into the voice store creator system as at 312. At step 314, when interacting with the interface 202, the merchant selects voice-assistant interactions as previously explained. To make voice-assistant interaction selections, the merchant selects supported voice interactions, such as for product searching, coupon-searching, deal of the day presentation, product purchasing and other ecommerce interactions the merchant desires. Optionally, the merchant selects the platform on which the voice assistant will operate, such as Amazon ALEXA. Optionally, the merchant selects or creates the interactions in a textual representation of a human language. Also, optionally, at 316 the merchant can configure other interactions, such as coupons, deal of the day, store locators, product search and other commerce-specific functions. Once interactions are configured and selected, the merchant submits the inputs to the store creator system 304 via the interface 202.

At step 318, the system 304 enables the merchant's products for voice-interactive searching. This process 318 includes connecting the voice store creator 304 to a merchant backend 306. In the exemplary process flow 300, the voice enable process connects to the merchant platform APIs, as at 320. To make this connection, the merchant can provide via the interface 202 the necessary API Keys and any other information required to connect to the APIs. It will be apparent to a person having ordinary skill in the art after having read this disclosure how to access product data stored on an existing ecommerce store backend. Voice-enabling the product data includes automatically tagging the product data. Tags and other metadata are generated in an augmentation module using rules, as previously explained. The augmentation results in searchable product data having search fields wherein the search is responsive to a voice-enabled interface.

The system also runs a recommendation algorithm to return personalized search results, as would be known to a skilled artisan after reading this disclosure. Likewise, the store 304 enables the other interactions configured on the merchant interface, as at 322. These interactions can include configuring coupons or other promotional transactions. Once the store creator 304 completes the augmentation and other configurations, process control reverts to the merchant interface where the merchant can elect to publish a voice assistant test case, as at 324.

In response to inputs at the merchant interface, the store creator 304 builds a voice interaction assistant for test, as at 326, generating the JSON structure, as previously explained. At step 328, the test voice assistant is published to development on the voice store platform 308. The merchant interface 202 provides the merchant access to the test store, as at 330. On the interface 202, test interactions and test transactions can be carried out as if the store were live to the public. Once the merchant is satisfied, the interface 202 enables the merchant to instruct the system to publish to the public, as at 332. In response to the command, the store creator 304 builds the voice assistant for production, as at 334. The store creator 304 passes the production voice assistant and control to the voice store platform 308, which publishes the store to the public, as at 336. Shoppers can then use the assistant to shop the ecommerce store using voice interaction.

FIG. 4 depicts an interface screen 400 for enabling voice interactions according to the principles of the invention. (BLUTAG is a registered trademark of Zumila, Inc.). The interface screen shows four categories of interactions, namely Product Purchase 402, Coupons 404, Return Policy 406 and Deals 408. Navigating to those interactions permits the merchant to enable voice interactions for particular products, coupons, returns and deals. The Edit Voice Interactions button 410 permits the user to navigate to an interface screen that provides edit capability on specific voice interactions.

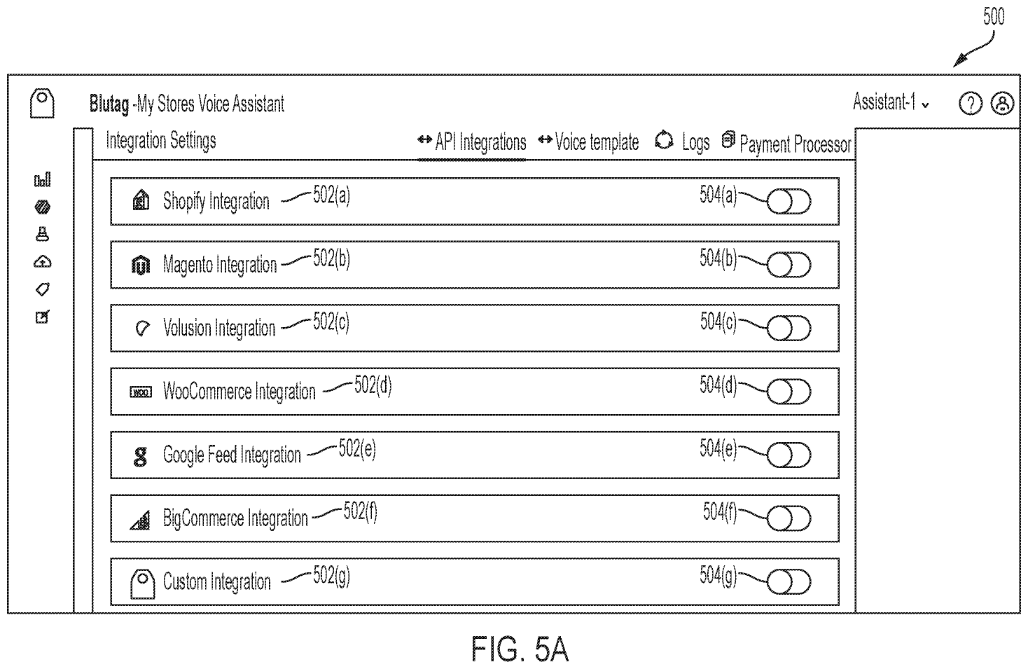

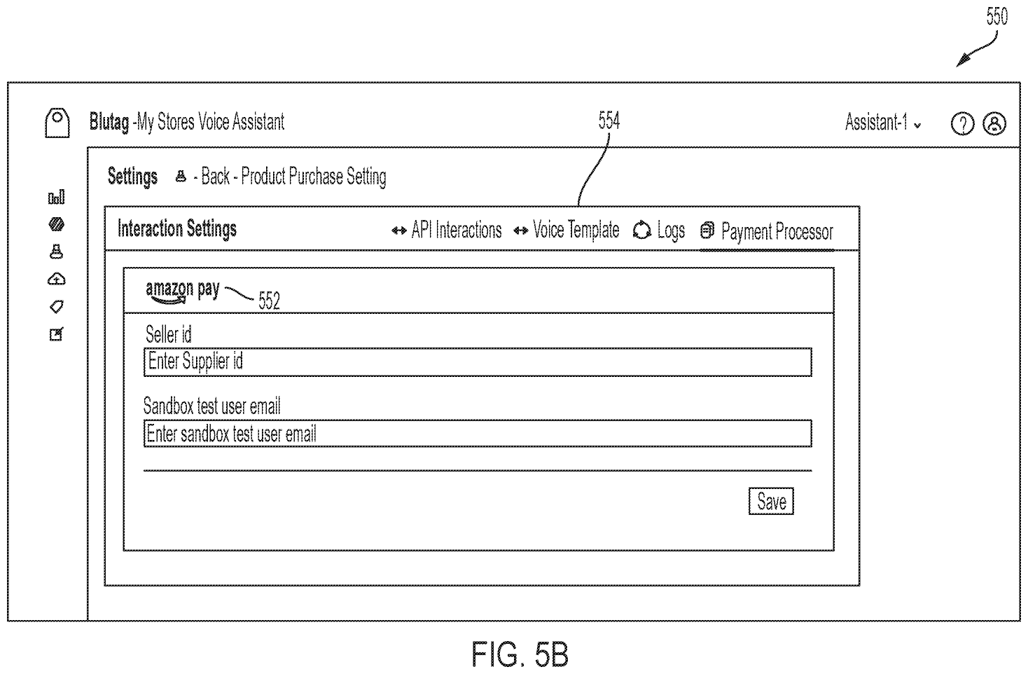

FIGS. 5A and 5B illustrate interface screens for API Settings and Payment Settings respectively. In the API Settings screen 500, the user interface presents the user with selections for enabling integrations with existing ecommerce platforms 502(a-f), as shown. (SHOPIFY name and associated image 502(a) are registered trademarks of Shopify Inc.) (MAGNETO name and image 502(b) are registered marks of Magneto Inc.) (VOLUSION name and image 502(c) are registered marks of Volusion Inc.) (WOOCOMMERCE name and image 502(d) are registered marks of Automattic Inc.) (GOOGLE FEED name and image 502(e) are registered marks of Google LLC.) (BIGCOMMERCE name and image 502(f) are registered marks of BigCommerce Inc.) Each of the integrations is enabled by toggling a button 504(a-f). Selecting an integration enables the store creator to integrate the selected interactions and configurations for a particular store. So, for example, should the merchant select integration for the SHOPIFY platform 502(a), then the backend for the SHOPIFY store is connected to the store creator and the interface permits the user to create voice interactions for those products. The integrations occur using APIs available at the ecommerce store. The exemplary screen 500 also shows that a custom integration 502(g) is enabled. In this case, there is a custom-built ecommerce store. As long as APIs are available, the user can connect to the custom store 502(g) using the toggle 504(g) provided.

The exemplary interface screens include settings for accepting payment 550, as shown in FIG. 5B. There are well-known payment platforms, such as PAYPAL and AMAZON PAY. The illustrative embodiment supports these payment platforms, which can be enabled in the created voice store. In the exemplary payment settings screen, AMAZON PAY 552 is enabled. (AMAZON PAY name and image 552 are registered trademarks of Amazon.com.) A person of ordinary skill in the art knows how to implement known payment platforms. In the settings according to the principles of the invention, the store creator generates voice interactions for a voice store, enabling the purchaser to select a payment method using a voice assistant. The voice templates 554 are accessible via the interface screen 550.

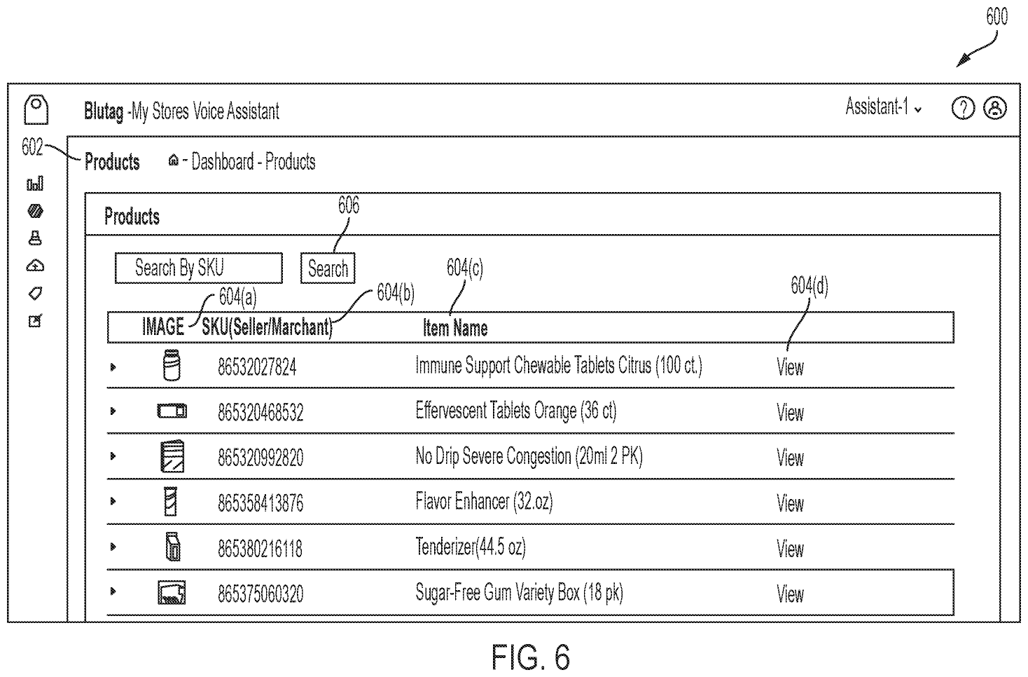

FIG. 6 illustrates an interface screen 600 for showing voice-enabled products according to the principles of the invention. The product data has been augmented to make them voice searchable, as previously explained. In this example, the user is shown the product image 604(a), the SKU number 604(b), the item name 604(c) and the option to view the product 604(d). A search button 606 permits the user to search for particular items. The voice assistant generated by the store creator provides the shopper the ability to search for these products. The merchant creates the voice assistant by connecting to an existing backend and importing the products the merchant wishes to make available via a voice store.

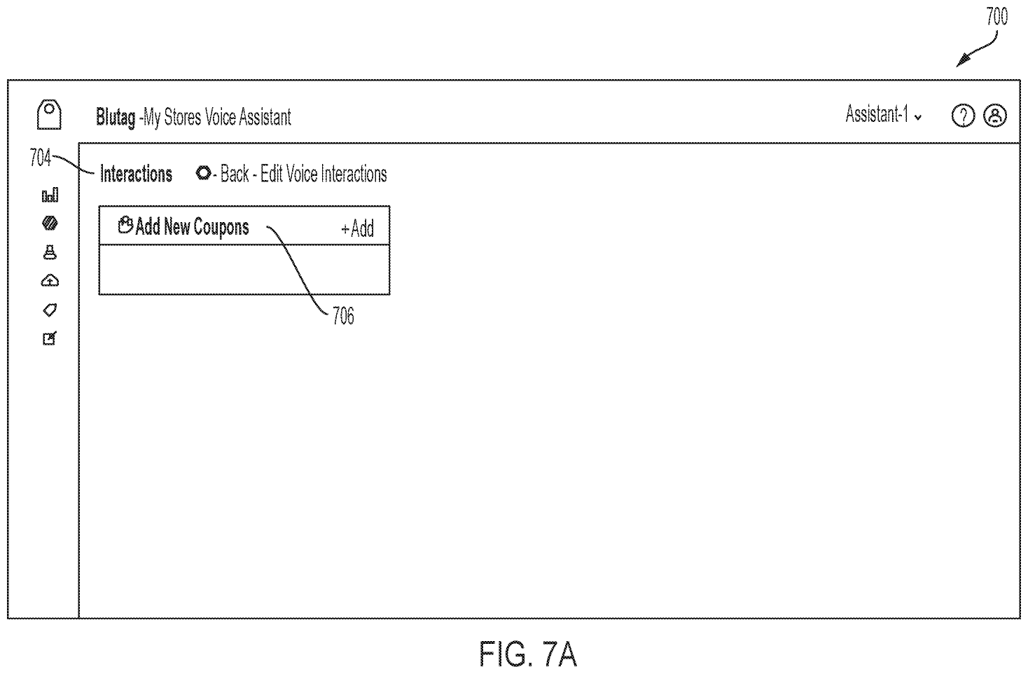

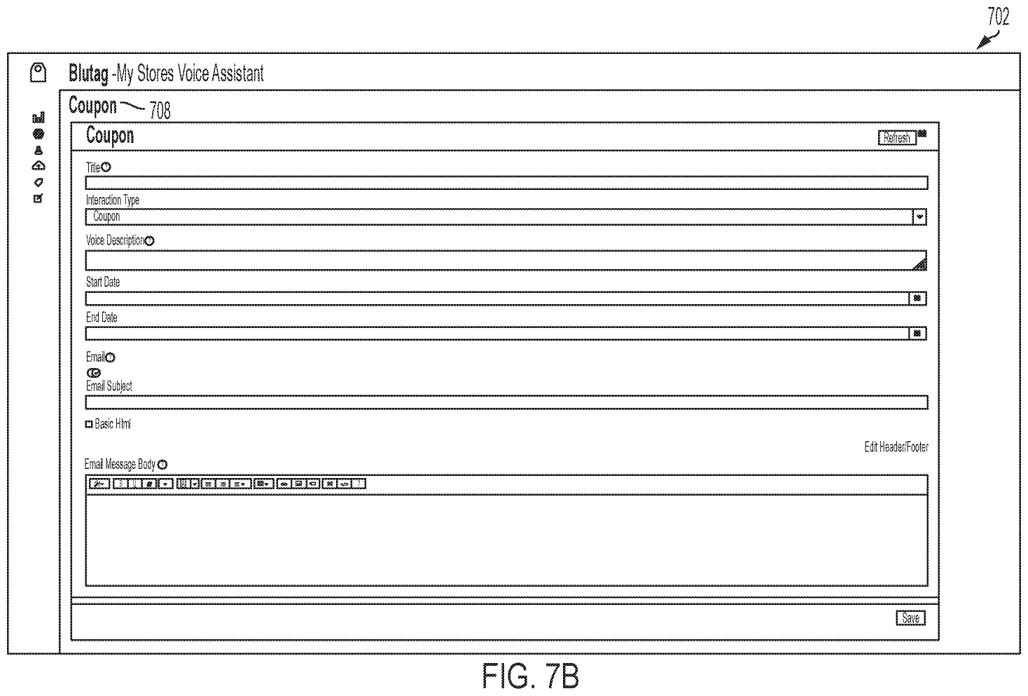

FIGS. 7A and 7B show screens 700 and 702 for creating coupons and enabling the use of coupons as a voice interaction. In the Create Coupons screen 700, the interface provides an activation for Add New Coupons 706. Activating this button brings the user a Coupon screen 702. On this screen the user inputs the details of the coupon, including the title, the voice description, the start date, the end date and other data necessary to implement the coupon. The store creator processes the inputs and creates a voice-searchable and voice-implementable coupon.

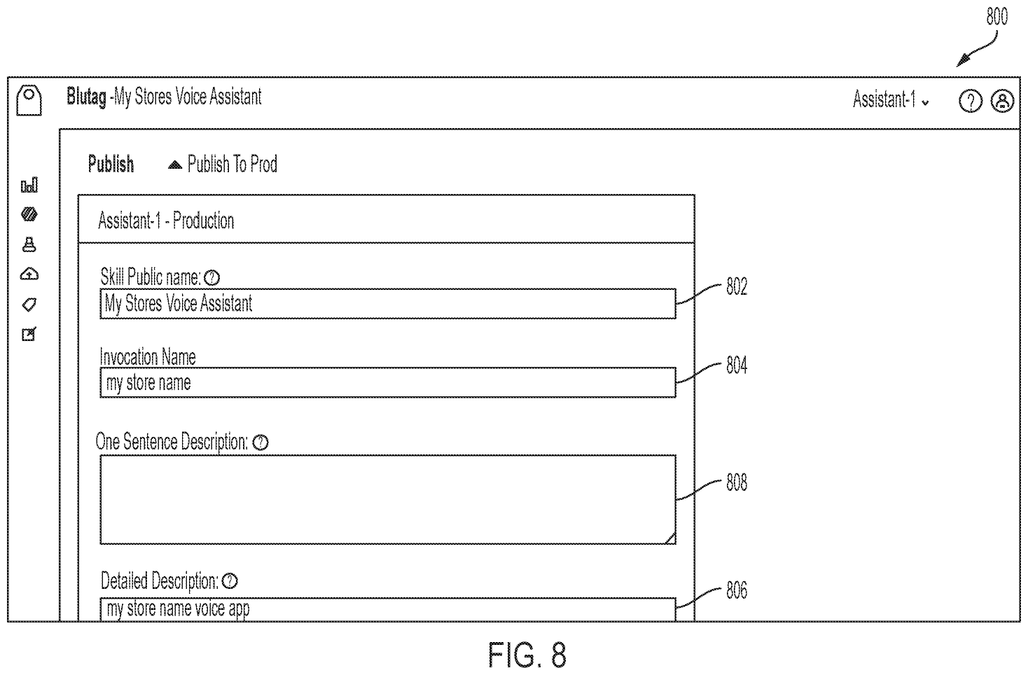

FIG. 8 shows an interface screen 800 according to the principles of the invention for publishing a voice store to production. There are fields for providing a public name for the store 802, for providing an invocation name 804, for providing a detailed description of the store 806 and for providing a one-sentence description of the store 808. The invocation name is the name the shopper will use to invoke the voice assistant.

It will be clear to those having ordinary skill in the art after reading the present disclosure how to make and use alternative embodiments where those operations described here are used in conjunction or used as separate processes in different embodiments of a voice store creation system and method.

What is claimed is:

1. A method for creating a voice interactive ecommerce store comprising:
connecting an ecommerce backend to a computing device of a voice store creator;
importing product data from the ecommerce backend to a data store of the voice store creator;
augmenting the product data to enable voice interactive searching of the product data; and
generating data publishable to a voice assistant application.

2. The method of claim 1 further comprising presenting for selection on an interface voice interactions and receiving selected ones of the voice interactions for the voice interactive ecommerce store.

3. The method of claim 1 further comprising presenting for selection on an interface ecommerce platforms for enabling the voice interactive ecommerce store and receiving at least one selected ecommerce platform.

4. The method of claim 1 wherein the importing product data comprises connecting to an API of the ecommerce backend.

5. The method of claim 1 wherein the augmenting comprises applying a plurality of rules to the product data, the rules generating searchable tags related to the product data.

6. The method of claim 1 further comprising:
generating the voice assistant application operable to enable users to access the voice interactive ecommerce store; and,
publishing the voice assistant application.

7. The method of claim 1 further comprising modifying the voice interactive ecommerce store to add customizable features.

8. The method of claim 7 wherein the customizable features comprise coupons.

9. The method of claim 7 wherein the customizable features include price reductions.

10. The method of claim 1 further comprising generating a web interface for interacting with the computing device.

11. The method of claim 1 further comprising selecting a voice assistant platform for publishing the voice assistant application.

12. The method of claim 1 wherein augmenting comprises tagging product data.

13. The method of claim 1 wherein the product data includes product images and the augmenting comprises generating metadata from the product images.

14. The method of claim 1 wherein the augmenting comprises selecting fields for searching and generating a search order of the selected fields.

15. The method of claim 1 further comprising generating recommendations using machine-learning algorithms.

16. A voice store creator system comprising:
a merchant facing interface;
a computing device operable to present outputs and receive inputs from the merchant facing interface and connectable to an ecommerce store backend in response to commands received from the merchant facing interface;
a data store accessible to the computing device and operable to store product data received from the ecommerce store backend and to store voice assistant interactions;
a voice assistant interaction selection module which when executed on the computing device presents voice assistant interactions for selection on the merchant facing interface;
an augmentation module which when executed on the computing device augments the product data such that the augmented product data enables voice interactive searching;
a voice assistant interaction generation module which when executed on the computing device generates a voice interaction assistant using selected ones of the voice assistant interactions; and
a publication module which when executed on the computing devices publishes the voice interaction assistant to a voice store platform.

17. The voice store creator of claim 16 further comprising a test module which when executed on the computing device publishes a voice assistant interaction test case to the merchant facing interface and in response to inputs from the merchant facing interface causes the voice assistant interaction generation module to generate a test voice interaction assistant publishable to the voice store platform.

18. The voice store creator of claim 17 wherein the test module which when executed on the computing device presents a test store generated by the voice store platform to the merchant facing interface.

19. The voice store creator of claim 18 wherein the voice assistant interaction generation module generates a voice interaction assistant in response to inputs received from the merchant facing interface.

20. The voice store creator of claim 19 wherein a publication module publishes a voice interaction assistant to a skills store.
